(19) United States
(12) Patent Application Publication
(10) Pub. No.: US 2016/0333816 A1
(43) Pub. Date: Nov. 17, 2016

(54) CONTROL DEVICE FOR INTERNAL COMBUSTION ENGINE

(71) Applicant: Toyota Jidosha Kabushiki Kaisha, Toyota-shi Aichi-ken (JP)

(72) Inventor: Takashi Suzuki, Miyoshi-shi Aichi-ken (JP)

(21) Appl. No.: 15/154,364

(22) Filed: May 13, 2016

(30) Foreign Application Priority Data
May 14, 2015 (JP) 2015-098748

(51) Int. Cl. F02D 41/30; B60K 6/442; F02D 41/40; B60K 6/24; F02D 41/34; F02D 41/38

(52) U.S. Cl. CPC F02D 41/3094; F02D 41/345; F02D 41/3818; F02D 41/406; B60K 6/24; B60K 6/442; F02D 2041/3881; Y10S 903/905; B60Y 2200/92; B60Y 2300/18125; B60Y 2300/432

(57) ABSTRACT

An engine is mounted in a vehicle configured to perform EV travelling. The engine includes a port injection valve that injects fuel to an intake port, a low pressure delivery pipe that stores the fuel for injection from the port injection valve, and a feed pump that compresses and thus supplies the fuel to the low pressure delivery pipe. An ECU, in the EV travelling, starts the fuel pump when a vehicle request power representing a driving power of the vehicle requested by the user exceeds a pump threshold value, and the ECU, in the EV travelling, generates a request to start the engine when the vehicle request power exceeds an engine threshold value larger than the pump threshold value.

### CROSS-REFERENCE TO RELATED APPLICATIONS

This nonprovisional application claims priority to Japanese Patent Application No. 2015-098748 filed on May 14, 2015, with the Japan Patent Office, the entire contents of which are hereby incorporated by reference.

### BACKGROUND

1. Technical Field

The present disclosure relates to a control device for an internal combustion engine, and more specifically, a control device to control a port injection type internal combustion engine.

2. Description of the Background Art

A hybrid vehicle including a port injection type engine is known. The port injection type engine includes a port injection valve injecting fuel to an intake port, a delivery pipe storing the fuel for injection from the port injection valve, and a fuel pump compressing and thus supplying the fuel to the delivery pipe. In order to adjust the pressure of the fuel in the delivery pipe (hereinafter also referred to as fuel pressure) to a value corresponding to a vehicular state, there is a demand for a technique for appropriately controlling the driving and stopping of a fuel pump.

For example, Japanese Patent Laying-Open No. 2000-064875 discloses a control to start a fuel pump in response to generation of an engine start request to increase fuel pressure at an early stage. Furthermore, for example, Japanese Patent Laying-Open No. 2004-278365 discloses a control to maintain fuel pressure at a prescribed value or larger by driving a fuel pump while an engine is stopped at idol stop.

### SUMMARY

In the hybrid vehicle disclosed in Japanese Patent Laying-Open No. 2000-064875, once an engine start request has been generated, then, before the engine's rotation is detected, the fuel pump is immediately started. However, as the fuel pump is started after the engine start request is generated, it takes a relatively long time to increase fuel pressure. Accordingly, there is a possibility that acceleration performance may be impaired.

On the other hand, in order to minimize a time lag from an acceleration operation to fuel injection and ignition, fuel pressure may constantly be maintained at a defined value or larger regardless of whether the engine start request is generated. In that case, however, while the time lag is smaller than when a fuel pressure less than the defined value is permitted, the amount of fuel leaking from the port injection valve increases, and there is a possibility of aggravated emission.

The present disclosure has been made to address the above issue, and an object of the present disclosure is to improve the startability of an engine of a port injection type (including a dual injection type) included in a hybrid vehicle, while suppressing aggravated emission, when an engine start request is generated.

The present disclosure in one aspect provides a control device for controlling an internal combustion engine, the internal combustion engine being mounted in a hybrid vehicle configured to perform EV travelling using a driving force generated by a rotating electric machine while the internal combustion engine is stopped. The internal combustion engine includes a port injection valve that injects fuel to an intake port, a reservoir unit that stores the fuel for injection from the port injection valve, and a fuel pump that compresses and thus supplies the fuel to the reservoir unit. The control device, in the EV travelling, starts the fuel pump when a vehicle request power representing a driving power of the hybrid vehicle requested by a user exceeds a first threshold value, and the control device, in the EV travelling, generates a request to start the internal combustion engine when the vehicle request power exceeds a second threshold value larger than the first threshold value.

According to the above configuration and method, when the vehicle request power is increased, then, before a request to start the internal combustion engine is generated, the fuel pump is started. As the fuel pump compresses fuel, the pressure of the fuel in the reservoir unit (i.e., the fuel pressure) will have been increased to some extent when the engine start request is generated. As such, after the request to start the internal combustion engine is generated, the fuel can be early injected from the port injection valve at an appropriate pressure to early complete starting the internal combustion engine. Furthermore, setting a difference between the first threshold value and the second threshold value to an appropriate value can increase a possibility that after the vehicle request power has reached the first threshold value the vehicle request power further reaches the second threshold value. Once the vehicle request power has reached the second threshold value, a request to start the internal combustion engine is generated, and a situation less easily occurs in which the fuel pump is started although the internal combustion engine is not started. Thus, wasteful fuel leakage from the port injection valve can be reduced, and aggravation of emission can be suppressed.

In some embodiments, the difference between the first threshold value and the second threshold value is set to be larger when the hybrid vehicle has a high vehicular speed than when the hybrid vehicle has a low vehicular speed.

According to the above configuration, the difference between the first threshold value and the second threshold value is set to be larger when the hybrid vehicle has a high vehicular speed than when the hybrid vehicle has a low vehicular speed, and accordingly, the first threshold value will be set to be small. That is, the fuel pump is more easily started for high vehicular speed than for low vehicular speed. In general, a request to start an internal combustion engine is more likely to be generated for high vehicular speed than for low vehicular speed, and early starting the fuel pump ensures a longer period of time for increasing fuel pressure before the request to start the internal combustion engine is generated.

In some embodiments, the hybrid vehicle further includes an operation unit that receives an operation for a user to request the EV travelling. The first and second threshold values for each vehicular speed are set to be larger when the EV travelling is requested through the operation of the operation unit than when the EV travelling is not requested through the operation of the operation unit.

When the EV travelling is requested by operating the operation unit (e.g., an EV switch) the EV travelling is given priority and the internal combustion engine is less easily started than when the EV travelling is not requested (i.e., when the HV travelling is performed). According to the above configuration, when the EV travelling is requested the first threshold value is set to be larger than for the HV travelling and the fuel pump is less easily started than for the HV travelling. Thus a situation less easily occurs in which although the fuel pump has been started a request to start the internal combustion engine is not generated, and wasteful energy consumption can be reduced.

In some embodiments, the hybrid vehicle further includes a power storage device that supplies electric power to a rotating electric machine. The hybrid vehicle is configured to switch a CD (charge depleting) mode in which an SOC of the power storage device is consumed and a CS (charge sustaining) mode in which the SOC is maintained within a prescribed range. The first and second threshold values for each vehicular speed are set to be larger for the CD mode than for the CS mode.

In the CD mode, large electric power can be supplied from the power storage device to the rotating electric machine, and the internal combustion engine is less likely to be started than in the CS mode. According to the above configuration, In the CD mode the first threshold value is set to be larger than in the CS mode, and the fuel pump is less easily started than in the CS mode. Thus a situation less easily occurs in which although the fuel pump has been started a request to start the internal combustion engine is not generated, and wasteful energy consumption can be reduced.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a block diagram generally showing a configuration of a hybrid vehicle having a control device mounted therein to control an engine according to the present disclosure.

FIG. 2 is a diagram for illustrating in detail a configuration of an engine and a fuel supply device shown in FIG. 1.

FIG. 3 is timing plots for illustrating an engine start control according to a comparative example.

FIG. 4 is timing plots for illustrating an engine start control according to a first embodiment.

FIG. 5 is a diagram for illustrating a method of setting a pump threshold value and an engine threshold value in the first embodiment.

FIG. 6 is a flowchart for illustrating the engine start control according to the first embodiment.

FIG. 7 is a diagram for illustrating a method of setting a pump threshold value and an engine threshold value in a second embodiment.

FIG. 8 is a flowchart for illustrating an engine start control according to the second embodiment.

FIG. 9 is a diagram for illustrating a CS mode and a CD mode.

FIG. 10 is a diagram for illustrating a method of setting a pump threshold value and an engine threshold value in the second embodiment in an exemplary variation.

FIG. 11 is a flowchart for illustrating an engine start control according to the second embodiment in the exemplary variation.

### DESCRIPTION OF THE EMBODIMENTS

The present disclosure will now be described in embodiments hereinafter in detail with reference to the drawings. In the figures, identical or corresponding components are identically denoted and will not be described repeatedly.

### First Embodiment

### Vehicular Configuration

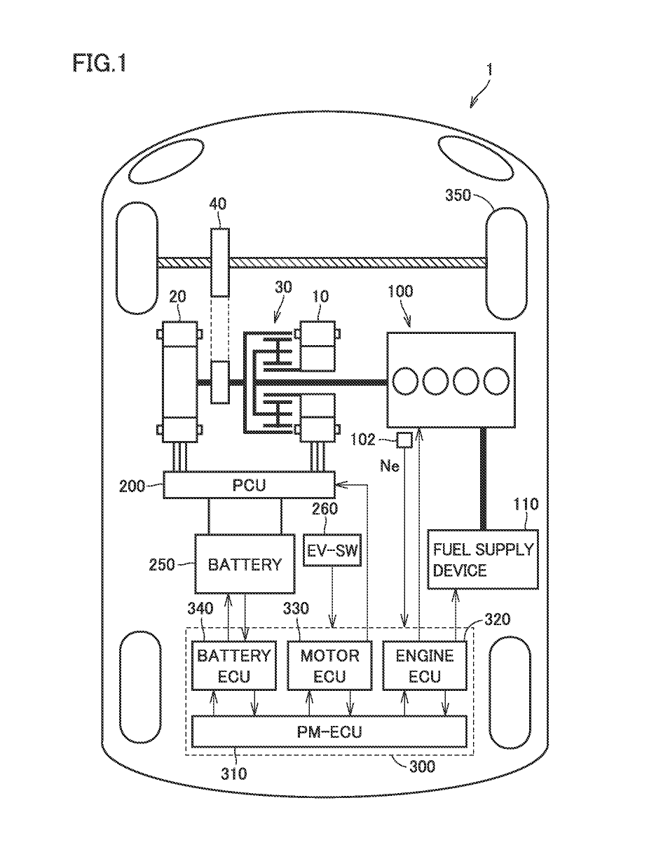

FIG. 1 is a block diagram generally showing a configuration of a hybrid vehicle having a control device mounted therein to control an engine according to the present disclosure. With reference to FIG. 1, a vehicle 1 is for example a series/parallel type hybrid vehicle, and includes an engine 100, a first motor generator (MG) 10, a second MG 20, a power split device 30, a reduction mechanism 40, a power control unit (PCU) 200, a battery 250, and an electronic control unit (ECU) 300.

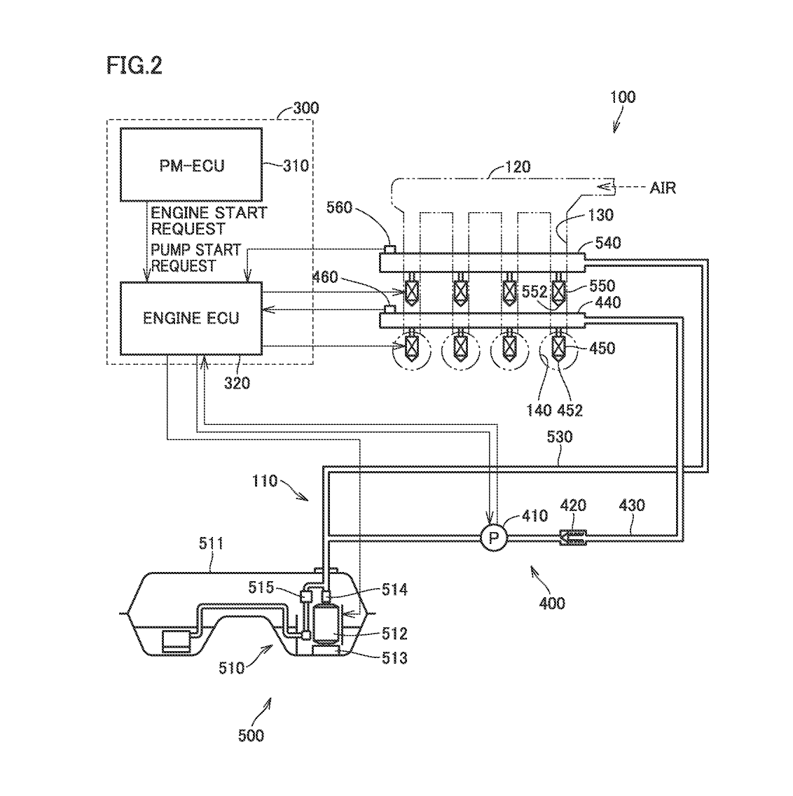

Engine 100 is configured including an internal combustion engine, such as a gasoline engine, and a fuel supply device 110 which supplies fuel to the internal combustion engine. The present embodiment illustrates an example which adopts as engine 100 an internal combustion engine of a dual injection type which employs both in-cylinder injection and port injection. Note, however, that in-cylinder injection is not essential, and engine 100 may be a port injection type which performs only port injection. Engine 100 is provided with an engine speed sensor 102 for sensing rotation speed (engine speed) Ne of engine 100. The configuration of engine 100 will be described in detail with reference to FIG. 2.

First MG 10 and second MG 20 are each a well known rotating electric machine which can operate as both an electric motor and an electric power generator, and are each a three phase alternating current, permanent-magnet type synchronous motor for example. First MG 10 and second MG 20 are both driven by PCU 200.

When first MG 10 starts engine 100, it rotates a crankshaft of engine 100 using electric power of battery 250. Furthermore, first MG 10 can also generate electric power using the motive power of engine 100. First MG 10 generates alternating current electric power which is converted into direct current electric power by PCU 200 and charged to battery 250. Furthermore, the alternating current electric power generated by first MG 10 may be supplied to second MG 20.

Second MG 20 rotates a drive shaft using at least one of the electric power received from battery 250 and the electric power generated by first MG 10. Furthermore, second MG 20 can also generate electric power by regenerative braking. Second MG 20 generates alternating current electric power which is converted into direct current electric power by PCU 200 and charged to battery 250.

Engine 100, first MG 10, and second MG 20 are coupled to one another via power split device 30. Second MG 20 has a rotation shaft coupled with a driving wheel 350 via reduction mechanism 40 and also coupled with a crankshaft of engine 100 via power split device 30. Power split device 30 is a planetary gear mechanism, for example, and configured to be capable of splitting the driving force of engine 100 to a crankshaft of first MG 10 and the rotation shaft of second MG 20.

PCU 200 is a drive device for driving first MG 10 and second MG 20 in response to a control signal issued from ECU 300. PCU 200 is configured for example including an inverter (not shown) and a converter (not shown).

Battery 250 is a power storage device for supplying electric power to first MG 10 and second MG 20. Battery 250 is configured for example including a nickel-metal hydride battery, a lithium ion battery or a similar rechargeable battery, or an electrical double layer capacitor or a similar capacitor, or the like.

ECU 300 includes an electronic control unit for power management (PM) (PM-ECU) 310, an electronic control unit for the engine (engine ECU) 320, an electronic control unit for a motor (motor ECU) 330, and an electronic control unit for the battery (battery ECU) 340. Each ECU is configured including a CPU (central processing unit), a ROM (read only memory), a RAM (random access memory), and an input/output interface circuit, although none of them is shown.

PM-ECU 310 is connected to engine ECU 320, motor ECU 330, and battery ECU 340 via a communication port (not shown). PM-ECU 310 communicates a variety of control signals and data with engine ECU 320, motor ECU 330 and battery ECU 340. For example, PM-ECU 310 calculates a vehicle request power P representing a driving power that the user requests vehicle 1, based on an amount of depressing of the accelerator pedal (not shown) (or an accelerator pedal position) AP and vehicular speed V. Furthermore, PM-ECU 310 outputs a request in response to vehicle request power P to engine ECU 320 to start engine 100 (or outputs an engine start request).

Engine ECU 320 is connected to engine 100 and fuel supply device 110. Engine ECU 320, in response to the engine start request from PM-ECU 310, controls engine 100 and fuel supply device 110. More specifically, engine ECU 320 calculates a required amount of fuel to be injected for each combustion, based on accelerator pedal position AP, an amount of intake air, engine speed Ne, etc. Furthermore, based on the calculated amount of fuel to be injected, engine ECU 320 timely outputs an injection command signal to an in-cylinder injection valve 450 (see FIG. 2) and a port injection valve 550 (see FIG. 2).

Motor ECU 330 is connected to PCU 200, and controls driving of first MG 10 and second MG 20. Battery ECU 340 is connected to battery 250, and controls battery 250 to charge/discharge electric power. Note that while ECU 300 includes a plurality of ECUs in the present embodiment, the number of ECUs is not limited to any specific number. ECU 300 may be some ECUs integrated together and may thus be configured of a smaller number of ECUs (e.g., a single ECU), or may be configured of a larger number of ECUs.

Vehicle 1 may travel as an EV using a driving force generated by second MG 20 while engine 100 is stopped. An EV switch (an operation unit) 260 is a manual switch operated by a user to select/clear the EV travelling. When the user desires the EV travelling, EV switch 260 is turned on by the user, whereas when the user desires the HV travelling, EV switch 260 is turned off by the user. Once EV switch 260 has been turned on, PM-ECU 310 outputs a variety of control signals to other ECUs according to a predetermined control procedure so that the EV travelling may be performed as long as possible. Once vehicle request power P has reached a prescribed start threshold value, then, even if the vehicle is travelling as an EV as EV switch 260 is operated, the EV travelling is cleared and an engine start request is generated.

FIG. 2 is a diagram for specifically illustrating a configuration of engine 100 shown in FIG. 1. With reference to FIG. 1 and FIG. 2, engine 100 is a series 4 cylinder gasoline engine for example, and includes fuel supply device 110, an intake manifold 120, an intake port 130, and four cylinders 140.

Each cylinder 140 is provided at a cylinder block. Intake air AIR to engine 100 flows from an intake port pipe through intake manifold 120 and intake port 130 into each cylinder 140 when a piston (not shown) in cylinder 140 descends.

Fuel supply device 110 includes a high pressure fuel feed mechanism 400 and a low pressure fuel feed mechanism 500.

High pressure fuel feed mechanism 400 includes a high pressure pump 410, a check valve 420, a high pressure fuel piping 430, a high pressure delivery pipe 440, four in-cylinder injection valves 450, and a high fuel pressure sensor 460.

High pressure fuel piping 430 couples high pressure pump 410 and high pressure delivery pipe 440 via check valve 420. High pressure delivery pipe 440 stores fuel for injection from in-cylinder injection valve 450.

Each of four in-cylinder injection valves 450 is an injector for in-cylinder injection which exposes a nozzle hole portion 452 in a combustion chamber of cylinder 140 associated therewith. When in-cylinder injection valve 450 is opened, the fuel compressed in high pressure delivery pipe 440 is injected through nozzle hole portion 452 into the combustion chamber.

High fuel pressure sensor 460 senses the pressure of the fuel stored in high pressure delivery pipe 440 and outputs to an engine ECU 320 a signal which indicates the sensed result.

Low pressure fuel feed mechanism 500 includes a fuel pumping unit 510, a low pressure fuel piping 530, a low pressure delivery pipe 540, four port injection valves 550, and low fuel pressure sensor 560.

Low pressure fuel piping 530 couples fuel pumping unit 510 and low pressure delivery pipe 540. Low pressure delivery pipe 540 stores the fuel for injection from port injection valve 550.

Each of four port injection valves 550 is an injector for port injection which exposes a nozzle hole portion 552 in intake port 130 communicating with cylinder 140 associated therewith. When port injection valve 550 is opened, the fuel compressed in low pressure delivery pipe 540 is injected through nozzle hole portion 552 into intake port 130.

Low fuel pressure sensor 560 senses the pressure of the fuel stored in low pressure delivery pipe 540 (a fuel pressure) and outputs to engine ECU 320 a signal which indicates the sensed result.

Fuel pumping unit 510 includes a fuel tank 511, a feed pump 512, a suction filter 513, a fuel filter 514, and a relief valve 515.

Fuel tank 511 stores the fuel for injection from in-cylinder injection valve 450 and port injection valve 550.

Feed pump 512 pumps up the fuel from an interior of fuel tank 511, compresses the fuel pumped up, and supplies it to low pressure fuel piping 530 and low pressure delivery pipe 540. Feed pump 512 can operate in response to a command signal output from engine ECU 320 to vary an amount discharged per unit time (unit: m³/sec) and a discharge pressure (unit: kPa). Thus, a pressure (fuel pressure) F in low pressure delivery pipe 540 can be set for example within a range of less than 1 MPa.

The configuration thus appropriately controlling feed pump 512 to deliver the fuel by an amount equivalent to that consumed by engine 100 can save energy required to compress the fuel. This can provide better fuel efficiency than a configuration which once provides excessive compression and then fixes pressure at nozzle hole portion 552 of port injection valve 550.

Suction filter 513 prevents suction of a foreign matter into the fuel. Fuel filter 514 removes a foreign matter from discharged fuel. Relief valve 515 is opened when the fuel discharged from feed pump 512 reaches an upper limit pressure, and relief valve 515 is held closed while the fuel discharged from feed pump 512 does not reach the upper limit pressure.

Engine ECU 320, in starting engine 100, initially performs fuel injection by port injection valve 550. Engine ECU 320 starts outputting an injection command signal to in-cylinder injection valve 450 when high fuel pressure sensor 460 senses that the fuel pressure in high pressure delivery pipe 440 exceeds a previously set value. Furthermore, engine ECU 320 employs port injection together for example when in-cylinder injection from in-cylinder injection valve 450 serves as a basis and the engine is in a specific operational condition in which in-cylinder injection does not allow a sufficient air fuel mixture to be formed (e.g., when engine 100 is started to warm up or operates under high load at low rotation). Alternatively, engine ECU 320 performs port injection from port injection valve 550 for example when in-cylinder injection from in-cylinder injection valve 450 serves as a basis and the engine operates under high load at high rotation, for which port injection is effective.

Vehicle 1 is characterized by a control which starts engine 100 when vehicle request power P is increased by an acceleration operation during the EV travelling (hereinafter also referred to as “engine start control”). In order to clarify a feature of the engine start control according to the present disclosure, an engine start control according to a comparative example will initially be described. Note that the configuration of a hybrid vehicle according to the comparative example is equivalent to the configuration of vehicle 1 shown in FIG. 1, and accordingly will not be described.

<Engine Start Control According to Comparative Example>

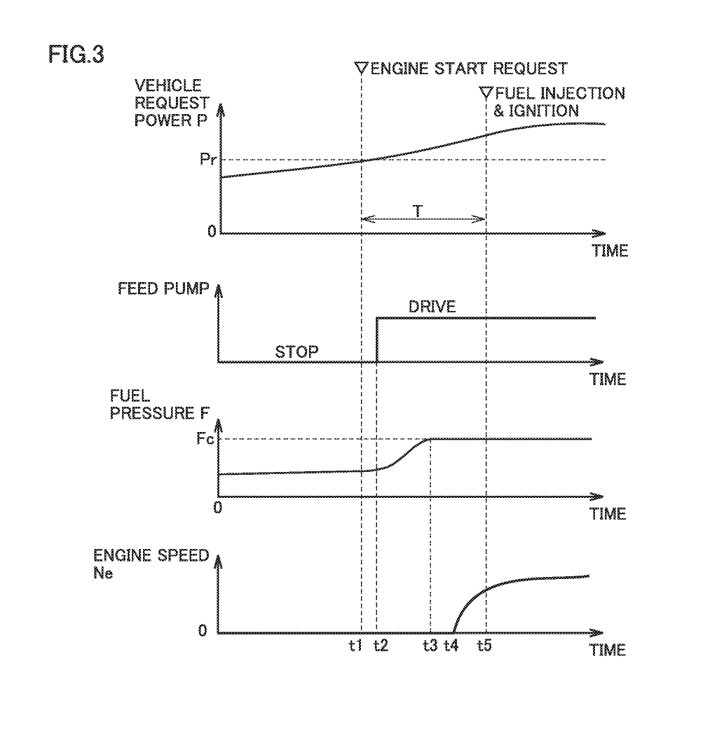

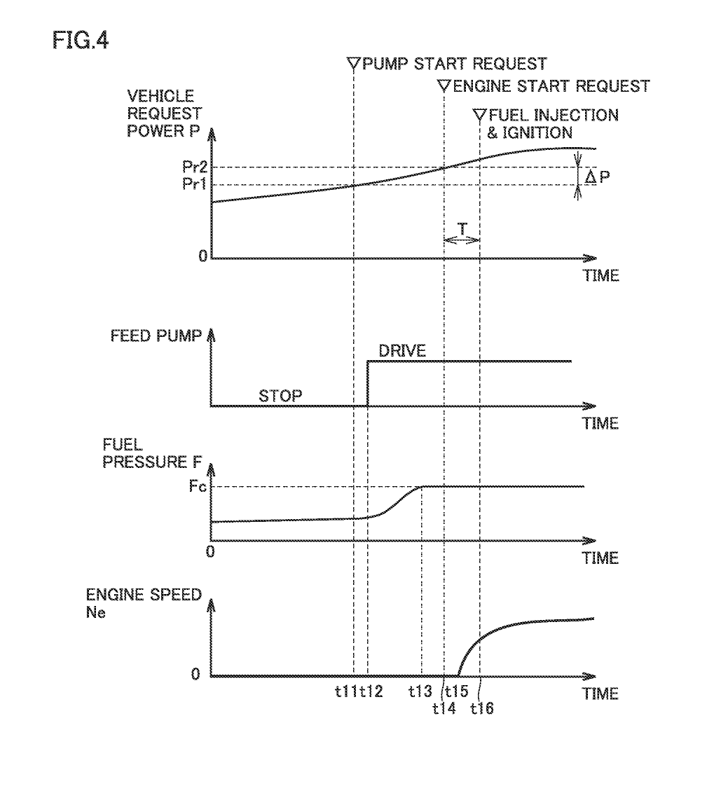

FIG. 3 is timing plots for illustrating the engine start control according to the comparative example. In FIG. 3, and FIG. 4 described later, an axis of abscissa represents elapsed time. An axis of ordinate represents vehicle request power P, driving/stopping of feed pump 512, fuel pressure F, and engine speed Ne, successively from the top.

With reference to FIG. 1-FIG. 3, the EV travelling is performed until time t1. Accordingly, engine 100 and feed pump 512 are both stopped. Here, a case will be described in which as the EV travelling continued for a long time, the fuel stored in low pressure delivery pipe 540 leaked and thus decreased, and fuel pressure F is lower than a defined value Fc applied for performing appropriate fuel injection.

The user operates the accelerator and thereby at time t1 vehicle request power P reaches a prescribed start threshold value (hereinafter also referred to as an “engine threshold value”) Pr. In response thereto, a request to start engine 100 is output from PM-ECU 310 to engine ECU 320. In response to the engine start request, engine ECU 320 drives feed pump 512 (at time t2). Thus, fuel pressure F starts to increase and reaches defined value Fc at time t3.

When a prescribed delay time has elapsed since time t1, or at time T4, first MG 10 rotates the crankshaft of engine 100 to start increasing engine speed Ne.

At time t5, the fuel compressed as feed pump 512 is driven is injected into intake port 130 from nozzle hole portion 552, and the injected fuel is ignited by an ignition plug (not shown). Starting engine 100 is thus completed.

Thus, in the comparative example, feed pump 512 is started after vehicle request power P has reached engine threshold value Pr and an engine start request has been generated. As such, if the EV travelling continues for a long period of time and fuel pressure F falls below defined value Fc, then it will take time to allow fuel pressure F to reach defined value Fc. As such, a relatively long time lag T will be required after an acceleration operation is performed and accordingly an engine start request is generated before fuel injection and ignition are performed and starting engine 100 is completed. That is, there is a limit in improving engine 100 in startability, and there is a possibility that vehicle 1 cannot be improved in acceleration performance.

<Pump Driving Control According to the Present Embodiment>

In contrast, the present embodiment adopts a configuration which sets a start threshold value for generating a request to start feed pump 512 (a pump start request) (hereinafter also referred to as a “pump threshold value”) Pr2, apart from engine threshold value Pr1 (see FIG. 4). Pump threshold value Pr2 is set to be smaller than engine threshold value Pr1. Accordingly, when vehicle request power P increases, a pump start request is generated prior to an engine start request, and feed pump 512 is thus started. As such, when the engine start request is generated, fuel pressure F has been increased to some extent, which can reduce time lag T to be shorter than the above described comparative example. This can improve engine 100 in startability, and hence vehicle 1 in acceleration performance.

FIG. 4 is timing plots for illustrating the engine start control in the first embodiment. With reference to FIG. 1, FIG. 2, and FIG. 4, in the present embodiment, pump threshold value Pr1 (a first threshold value) for generating a pump start request is set to be smaller than engine threshold value Pr2 (a second threshold value) for generating an engine start request.

At time t11, vehicle request power P reaches pump threshold value Pr1, and in response, a pump start request is output from PM-ECU 310 to engine ECU 320. Thus, feed pump 512 is driven (at time t12). As time elapses, fuel pressure F increases, and reaches defined value Fc at time t13.

At time t14, vehicle request power P reaches engine threshold value Pr2, and in response, an engine start request is output from PM-ECU 310 to engine ECU 320. Since fuel pressure F has already reached the defined value Fc, engine speed Ne starts to increase at time t15. At time t16, fuel injection and ignition are performed and starting engine 100 is completed.

Thus, according to the present embodiment, before an engine start request is generated, fuel pump 512 is started. As fuel pump 512 compresses fuel, fuel pressure F in low pressure delivery pipe 540 will have been increased to some extent when the engine start request is generated. Thus, when the present embodiment is compared with the comparative example shown in FIG. 3, the former reduces a period of time elapsing after the engine start request is generated before fuel pressure F reaches defined value Fc (in the FIG. 4 example, when the engine start request is generated, fuel pressure F has already reached defined value Fc). As a result, time lag T elapsing after the engine start request is generated before fuel injection and ignition are performed, is reduced. This can improve engine 100 in startability, and hence improve vehicle 1 in acceleration performance.

In view of minimizing time lag T, a pump driving request may be constantly turned on to maintain fuel pressure F constantly at defined value Fc or larger regardless of whether the engine start request is generated. In that case, however, feed pump 512 may be operated although engine 100 is not started. Thus, fuel pressure F becomes higher than in a case in which fuel pressure F is permitted to be less than defined value Fc, and the amount of fuel leaking from port injection valve 550 may be increased. The leaked fuel may aggravate emission provided when engine 100 is started. Furthermore, an energy consumption for driving feed pump 512 is increased, and fuel efficiency may be impaired.

In contrast, according to the first embodiment, feed pump 512 is started after vehicle request power P has reached pump threshold value Pr1. Setting a difference ΔP between pump threshold value Pr1 and engine threshold value Pr2 to an appropriate value can increase a possibility that vehicle request power P having reached pump threshold value Pr1 further reaches engine threshold value Pr2. Once vehicle request power P has reached engine threshold value Pr2, a request to start engine 100 is generated, and a situation less easily occurs in which feed pump 512 is started although engine 100 is not started. Thus, wasteful fuel leakage from port injection valve 550 can be reduced, and aggravation of emission can be suppressed. Furthermore, feed pump 512 is driven for a reduced period of time, and impaired fuel efficiency can be suppressed.

Hereinafter, an example of a method of setting pump threshold value Pr1 and engine threshold value Pr2 will be described. In some embodiments, pump threshold value Pr1 and engine threshold value Pr2 are each set for example depending on vehicular speed V.

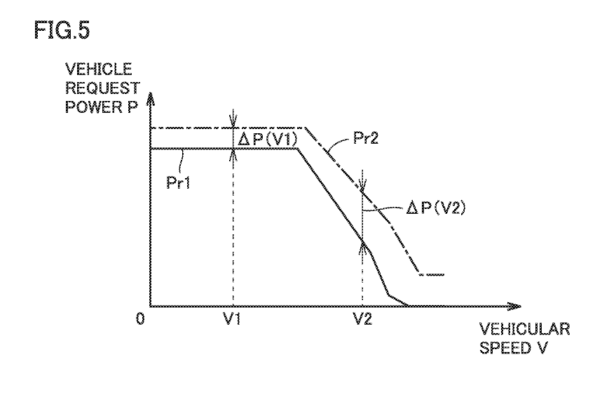

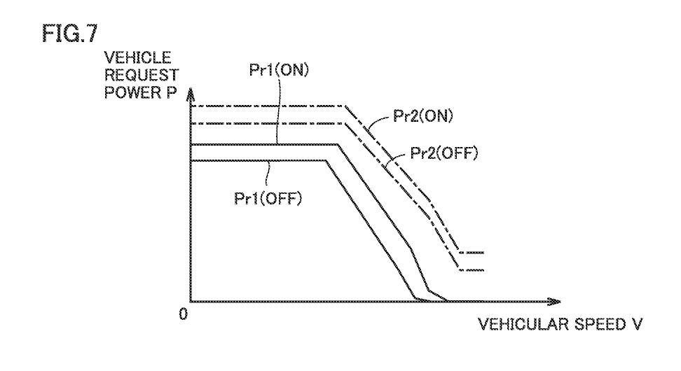

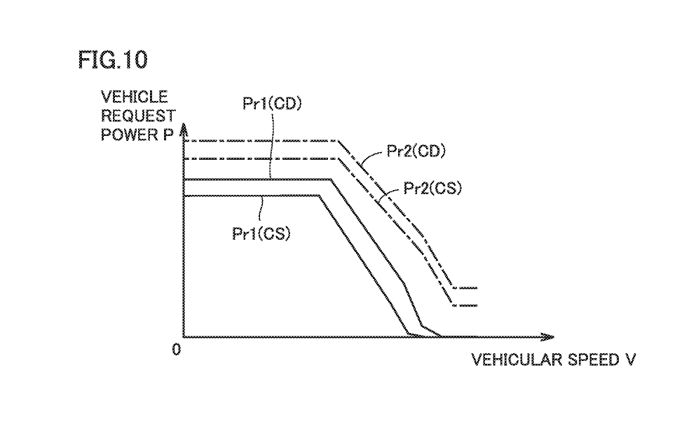

FIG. 5 is a diagram for illustrating an example of a method of setting pump threshold value Pr1 and engine threshold value Pr2 in the first embodiment. In FIG. 5, and FIG. 7 and FIG. 10 described later, an axis of abscissa represents vehicular speed V, and an axis of ordinate represents vehicle request power P.

With reference to FIG. 5, when vehicular speed V is relatively high, engine threshold value Pr2 is set to be lower and accordingly, the engine start request is more easily generated than when vehicular speed V is relatively low. Accordingly, if difference ΔP between pump threshold value Pr1 and engine threshold value Pr2 is set to be large, a situation less easily occurs in which although feed pump 512 has been started engine 100 is not started. Thus, in the present embodiment, difference ΔP is set to be larger for vehicular speed V of high speed than for vehicular speed V of low speed. This ensures a longer period of time for increasing fuel pressure F before an engine start request is generated. Note that difference ΔP may be set to be larger for vehicular speed V of higher speed.

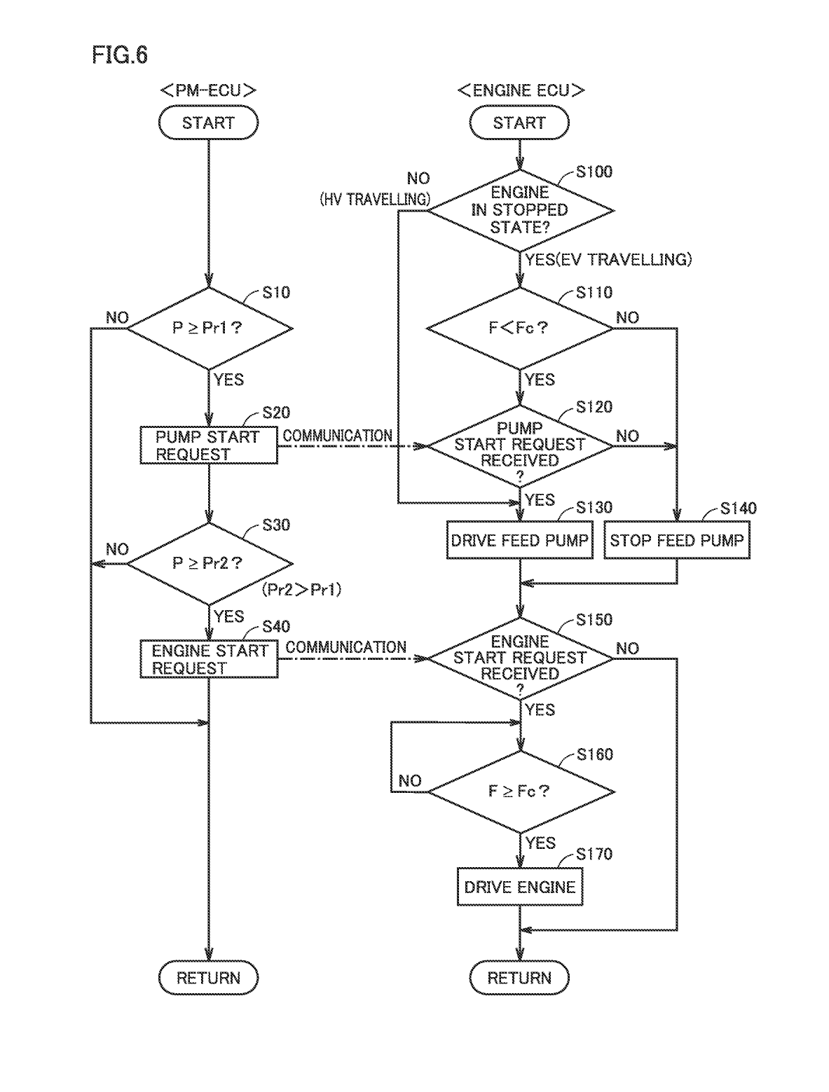

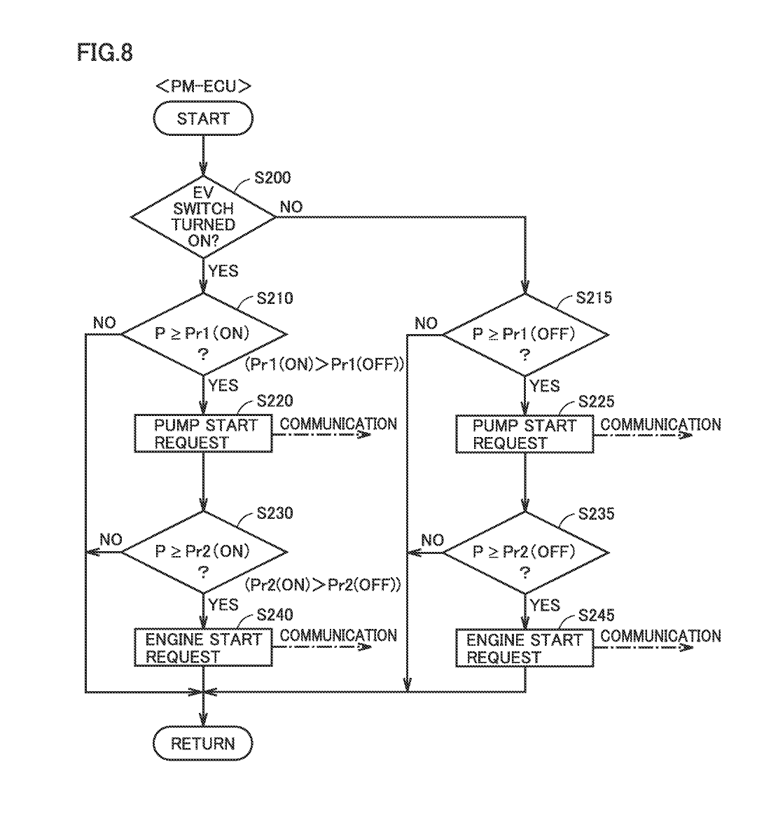

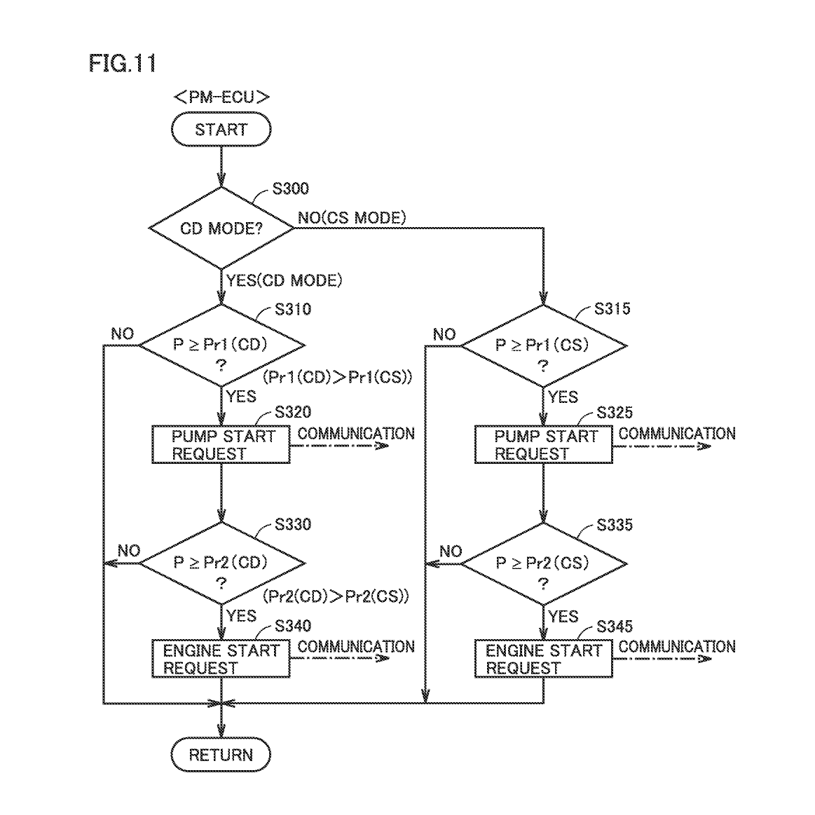

FIG. 6 is a flowchart for illustrating the engine start control according to the first embodiment. The flowcharts shown in FIG. 6, and FIG. 8 and FIG. 11 described later, are invoked from a main routine and executed when a prescribed condition is established or whenever a prescribed period of time elapses. While each step (hereinafter abbreviated as “S”) of these flowcharts is implemented basically by software processing performed by PM-ECU 310 or engine ECU 320, it may be implemented by hardware (an electronic circuit) produced in each ECU.

With reference to FIG. 1, FIG. 2, and FIG. 6, in S100, engine ECU 320 determines whether engine 100 is in a stopped state while the vehicle is traveling. When engine 100 is in the stopped state (YES in S100), i.e., when the EV travelling is performed, engine ECU 320 continues the process to S110.

In S110, engine ECU 320 determines whether fuel pressure F is less than defined value Fc, based on a detection signal received from low fuel pressure sensor 560. When fuel pressure F is defined value Fc or more (NO in S110), engine ECU 320 determines that it is not necessary to increase fuel pressure F to be higher than that, and engine ECU 320 stops feed pump 512 (or maintains the stopped state). When fuel pressure F is less than defined value Fc (YES in S110), ECU 300 continues the process to S120. Note that while in this flowchart the manner of the control is changed depending on a value of fuel pressure F sensed, the control may proceed with S120 without sensing fuel pressure F.

In S10, PM-ECU 310 calculates vehicle request power P based on accelerator pedal position AP and vehicular speed V, and determines whether vehicle request power P calculated is equal to or greater than pump threshold value Pr1. When vehicle request power P is equal to or greater than pump threshold value Pr1 (YES in S10), PM-ECU 310 outputs a pump start request to engine ECU 320 (S20) (see time t11 in FIG. 4).

In S120, engine ECU 320 determines whether the pump start request from PM-ECU 310 has been received. When the pump start request has not been received (NO in S120), engine ECU 320 determines that a possibility that an engine start request is immediately generated is low, and engine ECU 320 continues the process to S140 and maintains feed pump 512 in the stopped state.

In contrast, when the pump start request is received (YES in S120), engine ECU 320 determines that there is a possibility that an engine start request may soon be generated, and also determines that in order to appropriately inject fuel, it is necessary to increase fuel pressure F, and engine ECU 320 continues the process to S130 and drives feed pump 512 or (maintains it in a driven state) (see time t12 in FIG. 4). Thus, fuel pressure F increases (see time t13 in FIG. 4). Note that engine ECU 320 also drives feed pump 512 when engine 100 is in a driven state in S100 (NO in S100), i.e., when the HV travelling is performed.

Furthermore, in S30, PM-ECU 310 determines whether vehicle request power P is equal to or greater than engine threshold value Pr2. When vehicle request power P is equal to or greater than engine threshold value Pr2 (YES in S30), PM-ECU 310 outputs an engine start request to engine ECU 320 (S40) (see time t14 in FIG. 4).

In S150, engine ECU 320 determines whether the engine start request has been received from PM-ECU 310. When the engine start request has not been received (NO in S150), engine ECU 320 returns the process to a main routine without starting engine 100.

When the engine start request has been received (YES in S150), engine ECU 320 determines whether fuel pressure F is defined value Fc or larger (S160). If fuel pressure F is less than defined value Fc (No in S160), ECU 320 waits until fuel pressure F reaches defined value Fc, and ECU 320 then performs cranking, and fuel injection and ignition, and thus completes starting engine 100 (S170) (see time t16 in FIG. 4). Subsequently, engine ECU 320 returns the process to the main routine.

Note that when vehicle request power P is less than pump threshold value Pr1 in S10 (NO in S10) or vehicle request power P is less than engine threshold value Pr2 in S30 (NO in S30), PM-ECU 310 skips the subsequent steps and returns the process to the main routine.

Thus, according to the present embodiment, apart from engine threshold value Pr2, pump threshold value Pr1 smaller than engine threshold value Pr2 is set. By doing this, when vehicle request power P exceeds pump threshold value Pr1, feed pump 512 starts, and furthermore, when vehicle request power P exceeds engine threshold value Pr2, an engine start request is generated. Setting a difference ΔP between pump threshold value Pr1 and engine threshold value Pr2 to an appropriate value can increase a possibility that vehicle request power P having reached pump threshold value Pr1 further reaches engine threshold value Pr2. Once vehicle request power P has reached engine threshold value Pr2, an engine start request is generated, and a situation less easily occurs in which feed pump 512 is started although engine 100 is not started. Thus, wasteful fuel leakage from port injection valve 550 can be reduced, and aggravation of emission can be suppressed. Furthermore, when the present embodiment is compared with a configuration in which fuel pressure F is constantly maintained at defined value Fc or more, the former drives feed pump 512 for a reduced period of time and can thus suppress impaired fuel efficiency.

Note that, in the present embodiment, low pressure delivery pipe 540 corresponds to a “reservoir unit” according to the present disclosure. Feed pump 512 corresponds to a “fuel pump” according to the present disclosure. Furthermore, PM-ECU 310 and engine ECU 320 correspond to a “control device for an internal combustion engine” according to the present disclosure.

### Second Embodiment

While in the first embodiment a configuration has been described in which pump threshold value Pr1 and engine threshold value Pr2 are set depending on vehicular speed V, the method of setting the values is not limited thereto. As has been described above, vehicle 1 includes EV switch 260. In a second embodiment will be described a configuration in which pump threshold value Pr1 is set depending on vehicular speed V and pump threshold value Pr1 is switched in response to EV switch 260 being turned on/off.

FIG. 7 is a diagram for illustrating a method of setting pump threshold value Pr1 and engine threshold value Pr2 in the second embodiment. With reference to FIG. 7, for each vehicular speed V, an engine threshold value Pr2 (ON) for EV switch 260 turned on is set to be larger than an engine threshold value Pr2 (OFF) for EV switch 260 turned off. In other words, the EV travelling is more easily performed when EV switch 260 is on than when EV switch 260 is off.

Furthermore, in the present embodiment, pump threshold value Pr1 (ON) for EV switch 260 turned on and pump threshold value Pr1 (OFF) for EV switch 260 turned off have a relationship in magnitude set to match a relationship in magnitude that engine threshold values Pr1, Pr2 have. In other words, for each vehicular speed V, pump threshold value Pr1 (ON) is set to be larger than pump threshold value Pr1 (OFF). Thus a situation less easily occurs in which although a pump start request has been generated an engine start request is not generated, and wasteful energy consumption can be reduced.

FIG. 8 is a flowchart for illustrating the engine start control according to the second embodiment. Of the engine start control according to the second embodiment, the control by engine ECU 320 is equivalent to the control by engine ECU 320 shown in the FIG. 6 flowchart (see S100-S160). Accordingly, FIG. 8 only illustrates a control done by PM-ECU 310.

With reference to FIG. 8, in S200, PM-ECU 310 determines whether EV switch 260 is turned on or off. When EV switch 260 is on (YES in S200), PM-ECU 310 continues the process to S210.

In S210, PM-ECU 310 determines whether vehicle request power P is equal to or greater than pump threshold value Pr1 (ON). When vehicle request power P is equal to or greater than pump threshold value Pr1 (ON) (YES in S210), PM-ECU 310 outputs a pump start request to engine ECU 320 (S220).

In S230, PM-ECU 310 determines whether vehicle request power P is equal to or greater than engine threshold value Pr2 (ON). When vehicle request power P is equal to or greater than engine threshold value Pr2 (ON) (YES in S230), PM-ECU 310 outputs an engine start request to engine ECU 320 (S240).

Note that when vehicle request power P is less than pump threshold value Pr1 (ON) in S210 (NO in S210) or vehicle request power P is less than engine threshold value Pr2 (ON) in S230 (NO in S230), PM-ECU 310 skips the subsequent steps and returns to a main routine.

In contrast, in S200 when EV switch 260 is off (NO in S200), PM-ECU 310 continues the process to S215. S215 et seq. differ from the steps performed when EV switch 260 is on (S210 to S240), in that pump threshold value Pr1 (ON) is replaced with pump threshold value Pr1 (OFF) and that engine threshold value Pr2 (ON) is replaced with engine threshold value Pr2 (OFF). The other steps are equivalent to those of S210 to S240 that correspond thereto, and will not be described repeatedly.

Thus according to the second embodiment, the pump threshold value is set to be larger when EV switch 260 is on than when EV switch 260 is off. Thus a situation less easily occurs in which although feed pump 512 has been started an engine start request is not generated, and wasteful energy consumption can be reduced.

### Second Embodiment in Exemplary Variation

In the second embodiment a configuration has been described in which pump threshold value Pr1 is switched in response to EV switch 260 being turned on/off. When vehicle 1 has a CD (charge depleting) mode and a CS (charge sustaining) mode as travelling modes, pump threshold value Pr1 may be switched depending on the CD mode and the CS mode.

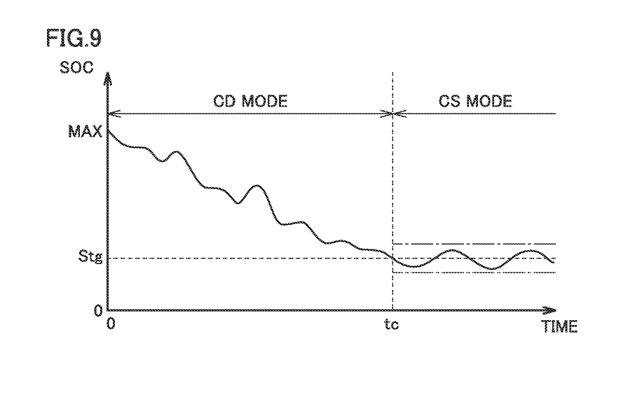

FIG. 9 is a diagram for illustrating the CS mode and the CD mode. With reference to FIG. 9, the axis of abscissa represents time and the axis of ordinate represents a state of charge (SOC) of battery 250. In FIG. 9 will be described an example in which after battery 250 has attained a fully charged state (SOC=MAX), the vehicle starts travelling in the CD mode.

The CD mode is basically a mode in which the electric power stored in battery 250 is consumed. When the vehicle is travelling in the CD mode, engine 100 is not started for maintaining the SOC. As such, although the SOC may be increased temporarily by regenerated electric power recovered when vehicle 1 decelerates or the like, or electric power generated as engine 100 is started, eventually the ratio of discharging is larger than that of charging, and as a whole, the SOC decreases as the vehicle travels more distance.

The CS mode is a mode in which the SOC is maintained within a prescribed range. As an example, the SOC decreases to a prescribed value Stg at time tc, and in response, the CS mode is selected, so that the SOC thereafter is maintained within a prescribed range (indicated in the figure by alternate long and short dashed lines). Specifically, when the SOC decreases, engine 100 is started, whereas when the SOC increases, engine 100 is stopped. In other words, in the CS mode, engine 100 is driven to maintain the SOC.

Engine 100 is also started in the CD mode when vehicle request power P exceeds the engine threshold value. On the other hand, engine 100 is also stopped in the CS mode when the SOC increases. In other words, the CD mode is not limited to the EV travelling causing the vehicle to travel with engine 100 constantly stopped. The CS mode is also not limited to the HV travelling causing the vehicle to travel with engine 100 constantly driven. The CS mode and the CD mode both allow both the EV travelling and the HV travelling.

FIG. 10 is a diagram for illustrating one example of a method of setting a start threshold value in the second embodiment in an exemplary variation. With reference to FIG. 10, in the present exemplary variation, as a pump threshold value for starting feed pump 512, Pr1 (CD) is set for the CD mode, and Pr1 (CS) is set for the CS mode. For a given vehicular speed V, pump threshold value Pr1 (CD) is larger than pump threshold value Pr1 (CS).

The ground for thus setting the pump threshold value is equivalent to the ground for setting the pump threshold value in response to EV switch 260 being turned on/off. In the CD mode the engine threshold value is set to be larger than in the CS mode, and engine 100 is thus less occasionally started than in the CS mode. Thus, in the CD mode the pump threshold value is set to be larger than in the CS mode so that the pump start request is less easily generated than in the CS mode so that a situation is less easily occurs in which although a pump start request has been generated, an engine start request is not generated. As a result, wasteful energy consumption can be reduced.

When this is described from a reversed viewpoint, in the CS mode engine 100 is more likely to be started than in the CD mode. Accordingly, if the pump threshold value is set to be small and accordingly, a pump start request is more easily generated, the energy consumed for driving feed pump 512 is less wastefully consumed. Furthermore, early generating a pump start request allows fuel to be earlier injected and ignited in response to an engine start request to thus earlier complete starting engine 100.

FIG. 11 is a flowchart for illustrating the engine start control according to the second embodiment in the exemplary variation. With reference to FIG. 1, FIG. 2, and FIG. 11, this flowchart is different from the FIG. 8 flowchart in that the former includes the step of determining whether vehicle 1 is travelling in the CD mode or the CS mode (S300) in place of the step of determining whether EV switch 260 is turned on/off (S200). The other steps are equivalent to those shown in the FIG. 8 flowchart that correspond thereto, and will not be described repeatedly.

Thus, according to the second embodiment in the exemplary variation, in the CD mode the pump threshold value is set to be larger than in the CS mode, and feed pump 512 is less easily started than in the CS mode. Thus a situation less easily occurs in which although feed pump 512 has been started an engine start request is not generated, and wasteful energy consumption can be reduced.

While the present disclosure has been described in embodiments, it should be understood that the embodiments disclosed herein are illustrative and non-restrictive in any respect. The scope of the present disclosure is defined by the terms of the claims, and is intended to include any modifications within the meaning and scope equivalent to the terms of the claims.

What is claimed is:

1. A control device for controlling an internal combustion engine, the internal combustion engine being mounted in a hybrid vehicle configured to perform EV travelling using a driving force generated by a rotating electric machine while the internal combustion engine is stopped, the internal combustion engine including:
a port injection valve configured to inject fuel to an intake port;
a reservoir unit configured to store the fuel for injection from the port injection valve; and
a fuel pump configured to compress and thus supply the fuel to the reservoir unit,
the control device, in the EV travelling being configured to start the fuel pump when a vehicle request power representing a driving power of the hybrid vehicle requested by a user exceeds a first threshold value,
the control device, in the EV travelling, being configured to generate a request to start the internal combustion engine when the vehicle request power exceeds a second threshold value larger than the first threshold value.

2. The control device according to claim 1, wherein
a difference between the first threshold value and the second threshold value is set to be larger when the hybrid vehicle has a high vehicular speed than when the hybrid vehicle has a low vehicular speed.

3. The control device according to claim 1, wherein:
the hybrid vehicle further includes an operation unit configured to receive an operation for a user to request the EV travelling; and
the first and second threshold values for each vehicular speed are set to be larger when the EV travelling is requested through the operation of the operation unit than when the EV travelling is not requested through the operation of the operation unit.

4. The control device according to claim 1, wherein:
the hybrid vehicle further includes a power storage device that supplies electric power to the rotating electric machine and is configured to switch between a charge depleting mode and a charge sustaining mode, wherein in the charge depleting mode a state of charge of the power storage device is consumed, and in the charge sustaining mode the state of charge is maintained within a prescribed range; and
the first and second threshold values for each vehicular speed are set to be larger for the charge depleting mode than for the charge sustaining mode.

5. A control device for controlling an internal combustion engine, the internal combustion engine being mounted in a hybrid vehicle configured to perform EV travelling using a driving force generated by a rotating electric machine while the internal combustion engine is stopped, the internal combustion engine including:
a port injection valve configured to inject fuel to an intake port;
a reservoir unit configured to store the fuel for injection from the port injection valve; and
a fuel pump configured to compress and thus supply the fuel to the reservoir unit,
the control device comprising:
an electronic control unit, in the EV travelling being configured to:
start the fuel pump when a vehicle request power representing a driving power of the hybrid vehicle requested by a user exceeds a first threshold value,
generate a request to start the internal combustion engine when the vehicle request power exceeds a second threshold value larger than the first threshold value.

6. The control device according to claim 5, wherein
a difference between the first threshold value and the second threshold value is set to be larger when the hybrid vehicle has a high vehicular speed than when the hybrid vehicle has a low vehicular speed.

7. The control device according to claim 5, wherein:
the hybrid vehicle further includes an operation unit configured to receive an operation for a user to request the EV travelling; and
the first and second threshold values for each vehicular speed are set to be larger when the EV travelling is requested through the operation of the operation unit than when the EV travelling is not requested through the operation of the operation unit.

8. The control device according to claim 7, wherein the operation unit is an EV switch.

9. The control device according to claim 5, wherein:
the hybrid vehicle further includes a power storage device that supplies electric power to the rotating electric machine and is configured to switch between a charge depleting mode and a charge sustaining mode, wherein in the charge depleting mode an state of charge of the power storage device is consumed, and in the charge sustaining mode the state of charge is maintained within a prescribed range; and
the first and second threshold values for each vehicular speed are set to be larger for the charge depleting mode than for the charge sustaining mode.

10. The control device according to claim 9, wherein the power storage device is a battery.

11. A hybrid vehicle configured to perform EV travelling using a driving force generated by a rotating electric machine while the internal combustion engine is stopped, the hybrid vehicle comprising:
a rotating electric machine that generates a driving force;
an internal combustion engine including:
a port injection valve configured to inject fuel to an intake port;
a reservoir unit configured to store the fuel for injection from the port injection valve; and
a fuel pump configured to compress and thus supply the fuel to the reservoir unit; and
an electronic control unit operatively connected to the rotating electric machine and the internal combustion engine, the electronic control divide configured to perform the EV traveling of the hybrid vehicle using the driving force generated by the rotating electric machine while the internal combustion engine is stopped,
the electronic control unit, in the EV travelling being configured to start the fuel pump when a vehicle request power representing a driving power of the hybrid vehicle requested by a user exceeds a first threshold value,
the electronic control unit, in the EV travelling, being configured to generate a request to start the internal combustion engine when the vehicle request power exceeds a second threshold value larger than the first threshold value.

12. The hybrid vehicle according to claim 11, wherein
a difference between the first threshold value and the second threshold value is set to be larger when the hybrid vehicle has a high vehicular speed than when the hybrid vehicle has a low vehicular speed.

13. The hybrid vehicle according to claim 11, wherein:
the hybrid vehicle further includes an operation unit configured to receive an operation for a user to request the EV travelling; and
the first and second threshold values for each vehicular speed are set to be larger when the EV travelling is requested through the operation of the operation unit than when the EV travelling is not requested through the operation of the operation unit.

14. The hybrid vehicle according to claim 13, wherein the operation unit is an EV switch.

15. The hybrid vehicle according to claim 11, wherein:
the hybrid vehicle further includes a power storage device that supplies electric power to the rotating electric machine and is configured to switch between a charge depleting mode and a charge sustaining mode, wherein in the charge depleting mode a state of charge of the power storage device is consumed, and in the charge sustaining mode the state of charge is maintained within a prescribed range; and
the first and second threshold values for each vehicular speed are set to be larger for the charge depleting mode than for the charge sustaining mode.

16. The hybrid vehicle according to claim 15, wherein the power storage device is a battery.
